(19) United States
(12) Patent Application Publication
(10) Pub. No.: US 2009/0276537 A1
(43) Pub. Date: Nov. 5, 2009

(54) Mechanisms for role negotiation in the establishment of secure communication channels in peer-to-peer environments

(76) Inventors: James W. Deverick, Williamsburg, VA (US); Marcia Z. Bryan, Williamsburg, VA (US); Tiffany L. Broadbent, Williamsburg, VA (US)

Correspondence Address: LUMEN PATENT FIRM, 350 Cambridge, Suite 100, PALO ALTO, CA, 94306, US

(21) Appl. No.: 12/317,077

(22) Filed: Dec. 17, 2008

Related U.S. Application Data
(60) Provisional application No. 61/008,962, filed on Dec. 20, 2007.

(51) Int. Cl. G06F 15/16

(52) U.S. Cl. 709/237

(57) ABSTRACT

A method of establishing secure communication channels in peer-to-peer environments is provided, that includes eliminating a role conflict between at least first peer and a second peer, determining which the peer will act as a client and which the peer will act as a server in a secure connection handshake, and when the first peer or the second peer detects a role conflict an attribute of the handshake message is used as a tiebreaker to determine a wait period, where the first peer or the second peer cancels its own requests, drops an incoming request or denies an incoming request and waits a random amount of time before resending the connection request, where a random time interval used by the peers can be different to reduce a chance for role conflict.

### CROSS-REFERENCE TO RELATED APPLICATIONS

This application claims priority from U.S. Provisional Patent Application 61/008,962 filed Dec. 20, 2007, which is incorporated herein by reference.

### FIELD OF THE INVENTION

The invention relates generally to communicating in a peer-to-peer (P2P) environment. More particularly, the invention relates to establishing a secure communication channel in a P2P environment, wherein at least two peers negotiate secure channel connections with each other.

### BACKGROUND

Typically, when endpoints of a network application wish to communicate securely, they negotiate a secret key that they will use to encrypt and decrypt their messages. This negotiation is usually implemented as a multiple-message “handshake.” One side of the connection initiates this process by sending a specially encoded message indicating that it wishes to acquire a secure communication channel. After agreeing on parameters for the connection, the two sides exchange segments of data that, when combined, allow each side to derive the same symmetric key used for securing application data. It is difficult for other parties to derive the same key by observing the handshake traffic.

A fundamental aspect of this key negotiation is the sequential ordering of the handshake messages. If any message is received out of order, the connection will fail. This is not a problem for applications in which requests for connections are sent from clients to persistent servers, such as in web and mail service. In peer-to-peer (P2P) environments, however, where the roles of client and server are relaxed, these handshake protocols can fail because it is not clear which side will begin the negotiation (and assume the client role).

In a P2P environment, any two peers may wish to establish a secure communication channel. Two peers may attempt to negotiate secure channels with each other at the same time, simultaneously sending handshake initiation messages to each other. In this case, both peers assume client roles, and when the initial handshake messages reach their destinations, both connection attempts will fail on protocol errors, because both sides were expecting server responses.

For example, Transport Layer Security (TLS) is a widely deployed security model that provides endpoint-to-endpoint encryption of application data. It provides good security for communication, but suffers from the above described race condition when two endpoints conflict for the client role in a new connection.

### SUMMARY OF THE INVENTION

In order to achieve secure communication among peers in a P2P environment, the security model should allow arbitrarily timed connection requests, including simultaneous requests from both ends of the same potential connection. Thus, peers should be able to detect and resolve role conflicts.

A role conflict occurs when a peer receives a secure connection request for a connection that it already sent a secure connection request to—the peer received a new request instead of a response to its existing secure connection request.

The present invention provides several new methods for establishing client and server roles during secure communication channel setup. These new techniques are applied either at the application level requiring no modification to the underlying security protocol, or integrated directly into the security protocol itself.

1) back off and retry: when a role conflict is detected by the application, the peer will cancel its existing request and drop or deny the incoming request. The peer will wait a random amount of time, and then retry the secure connection request if a secure connection has not already been established.

2) tiebreaker: an attribute of the handshake message is used as a tiebreaker between the peers. The tiebreaker determines which peer will act as the client and which one will act as the server in the secure connection handshake. The peer that becomes the server will cancel its secure connection request and send a response back to the other peer's request. The peer that becomes the client will drop or deny the incoming request and wait for a response to its request. If the tie cannot be broken, the incoming request should be dropped or denied and you should generate a new request with a new tiebreaker value.

3) tiebreaker and back off when peer detects a role conflict, it will use an attribute of the handshake message as a tiebreaker to determine the wait period. The peers cancel their own requests, drop or deny the incoming requests and wait a random amount of time before resending the connection request. In this approach, the random time intervals used by the peers can be different, possibly based on the tiebreaker value, to reduce the chances for subsequent role conflicts.

### DETAILED DESCRIPTION

### Back Off and Retry Mechanism

In this section, we describe how the back off and retry mechanism is applied at the application and the transport layer.

The following rules used by the receiving and sending peers define an algorithm that allows a P2P communications device to engage in secure communication with other peers using an unmodified client/server handshake protocol. Both sending and receiving peers maintain information about the existence of connections with other peers.

When a new message arrives, the receiving peer first checks to see if it has an existing connection with the source of the message.
If the receiving peer does not have an existing connection for the sender, the receiving peer assumes the server role, and participates in the new connection handshake. If the received message was not a handshake initiation request, then an error has occurred.
If the receiving peer does have an existing connection for the sender, the receiving peer passes the received message to the security engine associated with the connection for processing.
   If the message is part of a handshake, the engine will process the handshake step and modify the connection state accordingly.
   If the message contains application data and the handshake has completed, the engine will decrypt it and return it for delivery to the application. If the message contains application data, but the handshake has not completed, an error has occurred.

When a message is to be sent to another peer, the sending peer first checks to see if a connection exists for the destination of the message.
If the sending peer does not have an existing connection for the destination, the sending peer waits for a small random amount of time. After waiting, the sending peer checks for the existence of a connection again.
   If none is present still, the sending peer assumes the role of client, and initiates a new connection handshake.
   If a connection is now present, the sending peer assumes the role of server, and participates in the connection handshake.
If the sending peer does have an existing connection for the destination, the sending peer must determine whether the connection is ready for application data, or requires additional handshake processing.
   If the connection is in a handshake negotiation state, the sending peer participates in that handshake negotiation.
   If the connection has successfully completed a handshake, the sending peer provides the application data to the security engine for encryption and wire line transmission.
   If the connection is not in a handshake negotiation state, but has not successfully completed a handshake, an error has occurred.

Once the handshake is complete, application data may be encrypted and sent between the peers.

Because of the random nature of the waiting period before transmission of the new connection handshake message, it is still possible for two peers to collide on connection setup. If both peers randomly select the same wait time before sending the initial message, they will likely both select client roles. Because of this, the following additional rule applies to all connections in the handshake processing state:

If either client or server ever detects that an error has occurred, it destroys the connection associated with the error, and begins the process again.

This process can be repeated until the connection succeeds. Because each attempt will select different random wait times before sending the initial message, it is likely that one side will eventually be selected as the client.

Another implementation of this approach places the back of and retry mechanism in the underlying security protocol instead of in the application as we have just described. In this implementation, the algorithm for detecting and resolving role conflict using back off and retry is as follows:

When a new secure connection request arrives,
If there is not an existing connection, assume the server role.
If there is an existing connection, cancel the existing connection, drop the incoming request, calculate a random wait time and resend the request if no connection exists when random wait period is over.

### Tiebreaker Mechanism:

Another approach to resolving the client/server handshake role conflicts is to modify the underlying protocol to support the condition when both sides of the connection select the same role. In this case, the value of some attribute of the initial handshake message is used as a tiebreaker to determine which side will fill the client role. This attribute could, for example, be the Random value of a TLS or DTLS ClientHello message.

The following rules define a new algorithm that the underlying security protocol implements in order to break ties between two peers who wish to initiate secure communication with each other at the same time:

When a new connection request is received,
If the receiving peer does not have an existing connection to the sending peer, the receiving peer assumes the server role and participates in the handshake normally.
If the receiving peer does have an existing connection to the sending peer, and that connection has completed the handshake stage, the receiving peer treats the connection request as a renegotiation of the existing connection.
If the receiving peer previously sent a connection request to the sender, then both sides have chosen the client role. In this case, each side compares the value of the tiebreaker attribute of the handshake message it sent to the value of the tiebreaker attribute of the handshake message it received. The ordering of these tiebreaker attribute values determines which side will assume the client role and which side will assume the server role. Receipt of a handshake message with a tiebreaker attribute value greater than that of the message previously sent could, for example, indicate that the recipient should assume the server role.
   If the recipient determines that it should assume the server role as a result of the tie breaking analysis, it discards the handshake message that it previously sent, resets its local state to assume the server role, and processes the received message as a new connection.
   If the recipient determines that it should assume the client role as a result of the tie breaking analysis, it discards the message it just received, retains its client role state, and waits for the other peer to issue a server response.
   In one implementation, if it is not possible to resolve the tie because both sides have generated the same value for the tiebreaker attributes, each side discards both the sent and received handshake messages and starts the process again as new clients. This process is repeated until the role conflicts are resolved and the connection can be established.
      Tiebreaker with Back Off.

Another approach to resolving the role conflicts involves deriving back off behavior from the value of a tiebreaker attribute in the handshake messages.

When a new connection request is received:

If the receiving peer previously sent a connection request to the sender, then both sides have chosen the client role. Each side compares the value of the tiebreaker attribute of the handshake message it sent to the value of the tiebreaker attribute of the message it received. Whether and how the peers try to establish the connection again depends on the result of this comparison.

In one implementation of this approach, both peers discard both sent and received messages, and both could retry the connection with new handshake messages. Each side waits for an amount of time, functionally derived from the tiebreaker attribute value, before sending the new connection attempt.

In another implementation, one side, such as the one with the higher tiebreaker attribute value, sends a new connection attempt sooner by preferentially selecting a shorter wait period. This process is repeated until a connection attempt succeeds.

In another implementation, both peers discard the original sent and received packets, but only one peer attempts a new connection. This could, for example, be the peer that had the higher tiebreaker attribute value in the original connection attempt. In this example, the peer with the lower tiebreaker attribute value would wait for the other peer to issue the next connection attempt.

What is claimed:

1. A method of establishing secure communication channels in peer-to-peer environments comprising:
a. eliminating a role conflict between at least first peer and a second peer, wherein said first peer will cancel an existing request and drop or deny the incoming request, wherein said first peer will wait a random amount of time, and then retry the secure connection request if a secure connection has not already been established with said second peer;
b. determine which said peer will act as a client and which said peer will act as a server in a secure connection handshake, wherein when said first peer becomes said server a secure connection request is canceled by said first peer and a response is sent back to said second peer's request, wherein when said second peer becomes said client an incoming request is dropped or denied by said second peer and said second peer waist for a response to its request, wherein if a tie cannot be broken, said incoming request should be dropped or denied and said first peer or said second peer should generate a new request with a new tiebreaker value; and
c. when said first peer or said second peer detects a role conflict an attribute of the handshake message is used as a tiebreaker to determine a wait period, wherein said first peer or said second peer cancels its own requests, drops an incoming request or denies an incoming request and wait a random amount of time before resending the connection request, wherein a random time interval used by said peers can be different to reduce a chance for role conflict.
